(19) United States
(12) Patent Application Publication
(10) Pub. No.: US 2021/0224778 A1
(43) Pub. Date: Jul. 22, 2021

(54) SYSTEM FOR AUTOMATIC REGISTRATION OF CREDIT CARD PROCESSING APPLICATIONS

(71) Applicant: Goldmine World, Inc., Fairfax, VA (US)

(72) Inventor: Sung Bin Im, Oakton, VA (US)

(73) Assignee: Goldmine World, Inc., Fairfax, VA (US)

(21) Appl. No.: 17/055,618

(22) PCT Filed: May 14, 2019
(86) PCT No.: PCT/US19/32182

§ 371 Date: Nov. 16, 2020

Related U.S. Application Data
(60) Provisional application No. 62/671,362, filed on May 14, 2018.

(51) Int. Cl. G06Q 20/24; G06Q 20/34; G06Q 30/02; G06Q 10/06

(52) U.S. Cl. CPC G06Q 20/24; G06Q 10/0639; G06Q 30/0201; G06Q 20/34

(57) ABSTRACT

A system for automatically receiving and processing credit card processing applications includes a data store and a computer processor coupled to the data store and in communication through the Internet with a user device. The data store stores application form data and merchant applicant data. The computer processor is programmed, upon receiving an indication from a merchant applicant, to (i) serve a credit card processing application form via a web page or mobile application page to the merchant applicant via the Internet, the credit card processing application form comprising a plurality of data fields describing at least an identification of a merchant applicant and an identification of a level of credit card processing service to be purchased, (ii) receive and store in the data store credit card processing application data provided by the merchant applicant via the sales lead form, (iii) automatically process the credit card processing application data to determine that an application for credit card processing service is approved, and (iv) automatically transmit to the merchant applicant data indicating that the application for credit card processing service is approved.

This application is a non-provisional of U.S. Provisional Patent Application No. 62/671,362 filed May 14, 2018, the entire disclosure of which is incorporated herein by reference.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The present invention relates in general to the field of management systems, and in particular to a system that uses a web portal to serve forms and automatically manage a process whereby a merchant becomes authorized to receive credit card payments through a processor. In an embodiment, the problem to be solved is that computer systems are incapable of automatically guiding a merchant through a credit card processing application and payment process, automatically receiving and processing forms for such application, and approving the application. Further, existing computer systems do not provide sufficient ease-of-use for all user types.

### SUMMARY

The present system and method provides a web-accessible portal that provides credit card processing application guidance and tracking, and can be used by merchants, sales agents, and administrators. In an embodiment, the invention provides a web portal which allows administrators and/or sales agents to configure forms and pricing for credit card processing services into the system. The system is configured to prompt a merchant applicant for multiple discrete data fields associated with an application to accept credit card payments, including fields for factors such as the average or expected number of transactions per month, average or expected dollar value of such transactions, the expected number of card-not-present transactions per month, etc. The system can be configured to consult a pricing matrix to determine one or more offer prices for one or more appropriate levels of service in view of the factors provided by the merchant applicant. After automatically leading the application through the initial forms via the portal, the present system then automatically manages the application by providing, e.g., submission of application form data to an administrator or third-party processor for review, contacting the merchant applicant for more information where necessary, obtaining approval of the application from an administrator or third-party processor, and sending an indication of approval along with other processing details to the merchant. The present invention provides the benefit of greatly improved speed at which applications are submitted and processed, and increased numbers of processed merchant applications per month.

### BRIEF DESCRIPTION OF THE DRAWINGS

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 shows a flow chart illustrating a process for automatic registration in accordance with an embodiment of the invention.

FIG. 2 shows a block diagram of a data processing system that can be used in various embodiments of the disclosed systems and methods.

FIG. 3 shows a block diagram of a user device.

### DETAILED DESCRIPTION

Reference will now be made in detail to the preferred embodiments of the present invention, examples of which are illustrated in the accompanying drawings. The following description and drawings are illustrative and are not to be construed as limiting. Numerous specific details are described to provide a thorough understanding. However, in certain instances, well-known or conventional details are not described in order to avoid obscuring the description. References to one or an embodiment in the present disclosure are not necessarily references to the same embodiment; and, such references mean at least one.

In an embodiment, the present invention provides a server that serves a website and mobile application system that is configured to automatically serves a web-accessible portal that provides credit card processing application guidance and tracking.

The invention provides a portal that includes two parts, one for administrators and sales agents and one for merchants (customers). The server is configured to provide, through a web site and/or mobile application, a registration process that allows merchants to submit forms and documentation online in connection with applications to accept credit cards, and which processes such applications seamlessly to allow quick approvals of such applications.

With respect to Merchants who wish to sign up for services with the company operating the present system (e.g., customers who wish to sign up for credit card processing service with a company that provides credit card processing services), the system can be configured to use a Price Matrix that takes various parameters and provides a grid-like interface to allow setting of various rates with such Merchants, either with or without a Sales Agent involved. The price matrix allows the Merchant to pick a level of service in accordance with factors such as the number of credit card transactions per month that they expect to submit for processing, average transaction size in dollars, and method of accepting (card present, card not present, etc.), and to obtain a price quotation for that level of service. The price quotation may be a percentage of the transaction amount, a set fee, or a combination of these. The system may also be configured to provide a parameter for profit percentage limitations that administrators of the system are able to setup. The portal can provide this tool directly to Merchants so that they can sign up for credit card processing services (or other services) without a Sales Agent being involved.

Sales Agents can also use the above tool in their negotiations with potential customers from the Sales Leads. Once a price is settled by both the agent and potential customer, Sales Agents are able to submit documents on behalf of the customer to sign up for various services, such as card processing. The system can be configured to compensate the sales agent by regular installments as a portion of the revenue generated by the resulting sale. For example, where the sale is a contract for card processing services, the system can be configured to compensate the sales agent by a percentage of the monthly revenue to the card processor from the contract.

In an embodiment, the invention provides an automated process for new users to register to become Card Processing Merchants of the website. The system is configured to guide the user through various fields that must be filled in and uploading documentation that is required. The system provides e-signature support to allow processing of applications online. The system is configured to use the above-described Price Matrix tool to present Merchants with a customized card processing rate quote specific to the information that they inputted previously into the system. Fields such as Business Type, Monthly Volume, Average Ticket Size, and other fields provide the Price Matrix with the necessary data it needs to be able to process a Rate Quotation for each merchant. Once a merchant agrees with the suggested Rate Quotation, the system proceeds to collect necessary e-signatures for required documentation. The system is configured to guide the Merchant if any documents are missing and help them to submit everything that is needed until final administrator approval.

The invention can provide an online portal through which a merchant can register themselves to become a Card Processing Merchant. The system can be configured to provide the merchant with the necessary forms for becoming authorized to provide credit card processing services, submit the application, and manage the extensive approval process, all in a fully automated online system. In this respect, the system may be provided with the ability to accept electronic signatures in such forms. In the case where a merchant does not want to fill out the forms to become a Card Processing Merchant, but still desires to provide card processing services, the present invention can provide a portal by which an authorized Sales Agent can fill out the forms required on behalf of the merchant in exchange for a monetary or non-monetary benefit provided to the Sales Agent. The portal described above can be configured to allow such merchant to chat with such Sales Agent and request that the Sales Agent fill out the necessary forms. In this respect, the presently described system can be an intermediary between the provider of card processing services and a merchant who wishes to obtain or offer card processing services but does not have the expertise to manage the complex card processing application process. The system can provide a fully automated facility to allow online submission of the numerous forms required and management of the steps between submission of the application and the commencement of card processing services by the merchant.

In an embodiment, the server is configured to incorporate into the website and/or mobile application an online shopping mall for users to be able to purchase new equipment and services. Each new service has associated with it an automated workflow that generates the proper documentation and guides the user on each step of the approval process. For example, ATM purchases can be accompanied by necessary ATM documentation and instructions on what supporting documents need to be uploaded. It provides Merchants with options such as online payment or a leasing program with various pricing based on approved credit levels. The online shopping mall may also include Point of Sale equipment with instructions on the necessary documentation and supporting documents to purchase this equipment. Prices for such equipment or services may be a set price set by an administrator or may be set in accordance with an online auction system wherein users can bid for equipment or processing services.

In an embodiment, the invention can provide all users with dashboards that are linked to the main system and allow display of status of documents submitted and pending actions that need to be taken by either the Merchant, Agent, or Administrator. Administrators are able to oversee all aspects of the system and change various parameters. User security and user roles are maintained by the Admin as well.

Any type of company can use or provide the processes or systems described above. Non-limiting examples of such users or providers include, e.g., credit card processors, phone service providers, insurance companies, and mortgage companies.

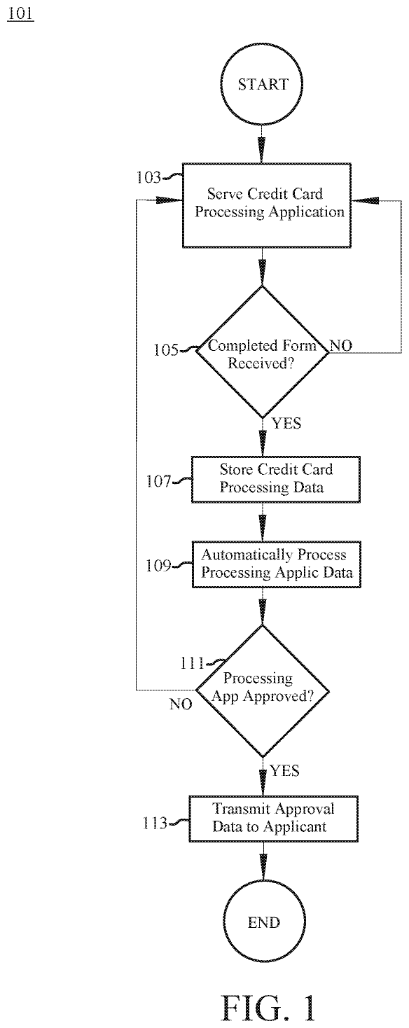

FIG. 1 shows a flow chart illustrating a process 101 for automatic registration in accordance with an embodiment of the invention. The process is executed by a system for automatically receiving and processing credit card processing applications which includes a data store and a computer processor that is coupled to the data store and in communication through the Internet with a user device. The data store includes application form data and merchant applicant data. The computer processor coupled to the data store is programmed, upon receiving an indication from a merchant applicant, to execute a series of steps.

At step 103, the system serves a credit card processing application form via a web page or mobile application page to the merchant applicant via the Internet. The credit card processing application form includes a plurality of data fields describing an identification of a merchant applicant and an identification of a level of credit card processing service to be purchased.

At step 105, the system then receives credit card processing application data provided by the user via the credit card processing application form, and checks to determine if the credit card processing application data is complete. If not, the system serves a further credit card processing application form via a web page or mobile application page to the merchant applicant via the Internet. If so, the system stores the credit card processing application data in the data store at step 107.

The system then, at step 109, automatically processes the credit card processing application data to determine that an application for credit card processing service is approved. At step 111, if the application for credit card processing service is not approved, the system serves further credit card processing application data to the merchant applicant. If the application for credit card processing service is approved, the system then at step 113 automatically transmits to the merchant applicant data indicating that the application for credit card processing service is approved.

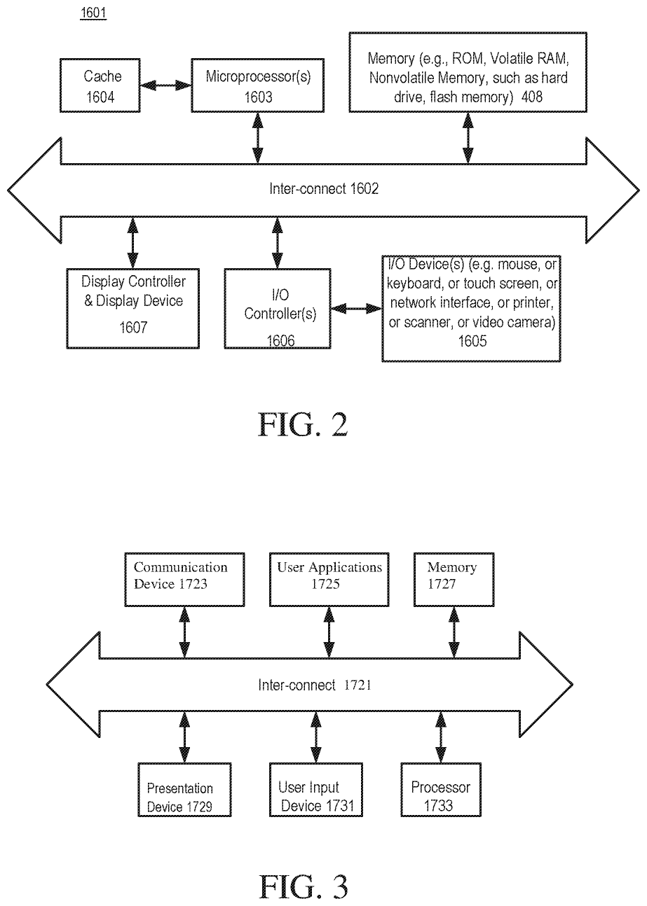

FIG. 2 shows a block diagram of a data processing system that can be used in various embodiments of the disclosed systems and methods. While FIG. 2 illustrates various components of a computer system, it is not intended to represent any particular architecture or manner of interconnecting the components. Other systems that have fewer or more components may also be used.

In FIG. 2, the system 1601 includes an inter-connect 1602 (e.g., bus and system core logic), which interconnects a microprocessor(s) 1603 and memory 1608. The microprocessor 1603 is coupled to cache memory 1604 in the example of FIG. 2.

The inter-connect 1602 interconnects the microprocessor(s) 1603 and the memory 1608 together and also interconnects them to a display controller and display device 1607 and to peripheral devices such as input/output (I/O) devices 1605 through an input/output controller(s) 1606. Typical I/O devices include mice, keyboards, modems, network interfaces, printers, scanners, video cameras and other devices that are well known in the art.

The inter-connect 1602 may include one or more buses connected to one another through various bridges, controllers and/or adapters. In one embodiment the I/O controller 1606 includes a USB (Universal Serial Bus) adapter for controlling USB peripherals, and/or an IEEE-1394 bus adapter for controlling IEEE-1394 peripherals.

The memory 1608 may include ROM (Read-Only Memory) and volatile RAM (Random Access Memory), and non-volatile memory data store, such as hard drive, flash memory, etc. Volatile RAM is typically implemented as dynamic RAM (DRAM) that requires power continually in order to refresh or maintain the data in the memory. Non-volatile memory data store is typically a magnetic hard drive, a magnetic optical drive, or an optical drive (e.g., a DVD RAM), or other type of memory system which maintains data even after power is removed from the system. The non-volatile memory data store may also be a random access memory. The non-volatile memory data store can be a local device coupled directly to the rest of the components in the data processing system. A non-volatile memory data store that is remote from the system, such as a network storage device coupled to the data processing system through a network interface such as a modem or Ethernet interface, can also be used.

In an embodiment, one or more servers supporting the platform are implemented using one or more data processing systems as illustrated in FIG. 2. In an embodiment, user devices such as those used to access the user interfaces described above are implemented using one or more data processing system as illustrated in FIG. 2.

In some embodiments, one or more servers of the system illustrated in FIG. 2 are replaced with the service of a peer-to-peer network or a cloud configuration of a plurality of data processing systems, or a network of distributed computing systems. The peer-to-peer network, or cloud-based server system, can be collectively viewed as a server data processing system.

Embodiments of the system disclosed above can be implemented via the microprocessor(s) 1603 and/or the memory 1608. For example, the functionalities described above can be partially implemented via hardware logic in the microprocessor(s) 1603 and partially using the instructions stored in the memory 1608. Some embodiments are implemented using the microprocessor(s) 1603 without additional instructions stored in the memory 1608. Some embodiments are implemented using the instructions stored in the memory 1608 for execution by one or more general-purpose microprocessor(s) 1603. Thus, the disclosure is not limited to a specific configuration of hardware and/or software.

FIG. 3 shows a block diagram of a user device. In FIG. 3, the user device includes an inter-connect 1721 connecting a communication device 1723, such as a network interface device, a presentation device 1729, such as a display screen, a user input device 1731, such as a keyboard or touch screen, user applications 1725 implemented as hardware, software, firmware or a combination of any of such media, such various user applications (e.g. apps), a memory/data store 1727, such as RAM or magnetic storage, and a processor 1733 that, inter alia, executes the user applications 1725.

In one embodiment, the user applications implement one or more user interfaces displayed on the presentation device 1729 that provides users and the system the capabilities to, for example, access a Wide Area Network (WAN) such as the Internet, and display and interact with user interfaces provided by the platform, such as, for example the user interfaces described above in this disclosure. In an embodiment, users use the user input device 1731 to interact with the device via the user applications 1725 supported by the device.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

Thus, there has been disclosed above a system that uses a web portal to receive and process applications for credit card processing that achieves substantial benefits over conventional systems, such as increased flexibility, faster distribution of data on merchant applicants to a processing company, lower local processing overhead and lower user error in connection with execution such applications.

Reference in this specification to “an embodiment” or “the embodiment” means that a particular feature, structure, or characteristic described in connection with the embodiment is included in at least an embodiment of the disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The present invention is described above with reference to block diagrams and operational illustrations of methods and devices to receive and process credit card processing applications. It is understood that each block of the block diagrams or operational illustrations, and combinations of blocks in the block diagrams or operational illustrations, may be implemented by means of analog or digital hardware and computer program instructions. These computer program instructions may be stored on computer-readable media and provided to a processor of an ASIC, general-purpose computer, special purpose computer, or other programmable data processing apparatus, such that the instructions, which execute via the processor of the computer or other programmable data processing apparatus, implements the functions/acts specified in the block diagrams or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

At least some aspects disclosed can be embodied, at least in part, in software. That is, the techniques may be carried out in a special purpose or general-purpose computer system or other data processing system in response to its processor, such as a microprocessor, executing sequences of instructions contained in a memory/data store, such as ROM, volatile RAM, non-volatile memory, cache or a remote storage device. Functions expressed in the claims may be performed by a processor in combination with memory storing code and should not be interpreted as means-plus-function limitations.

Routines executed to implement the embodiments may be implemented as part of an operating system, firmware, ROM, middleware, service delivery platform, SDK (Software Development Kit) component, web services, or other specific application, component, program, object, module or sequence of instructions referred to as “computer programs.” Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A machine-readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer-to-peer networks. Different portions of the data and instructions can be obtained from different centralized servers and/or peer-to-peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine-readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others.

In general, a machine-readable medium includes any mechanism that provides (e.g., stores) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

As used herein, and especially within the claims, ordinal terms such as first and second are not intended, in and of themselves, to imply sequence, time or uniqueness, but rather are used to distinguish one claimed construct from another. In some uses where the context dictates, these terms may imply that the first and second are unique. For example, where an event occurs at a first time, and another event occurs at a second time, there is no intended implication that the first time occurs before the second time. However, where the further limitation that the second time is after the first time is presented in the claim, the context would require reading the first time and the second time to be unique times. Similarly, where the context so dictates or permits, ordinal terms are intended to be broadly construed so that the two identified claim constructs can be of the same characteristic or of different characteristic.

The above embodiments and preferences are illustrative of the present invention. It is neither necessary, nor intended for this patent to outline or define every possible combination or embodiment. The inventor has disclosed sufficient information to permit one skilled in the art to practice at least one embodiment of the invention. The above description and drawings are merely illustrative of the present invention and that changes in components, structure and procedure are possible without departing from the scope of the present invention as defined in the following claims. For example, elements and/or steps described above and/or in the following claims in a particular order may be practiced in a different order without departing from the invention. Thus, while the invention has been particularly shown and described with reference to embodiments thereof, it will be understood by those skilled in the art that various changes in form and details may be made therein without departing from the spirit and scope of the invention.

What is claimed is:

1. A system for automatically receiving and processing credit card processing applications, comprising:
a) a data store including application form data and merchant applicant data; and
b) a computer processor coupled to the data store and in communication through the Internet with a user device and programmed, upon receiving an indication from a merchant applicant, to:
i) serve a credit card processing application form via a web page or mobile application page to the merchant applicant via the Internet, the credit card processing application form comprising a plurality of data fields describing at least an identification of a merchant applicant and an identification of a level of credit card processing service to be purchased;
ii) receive and store in the data store credit card processing application data provided by the user via the credit card processing application form;
iii) automatically process the credit card processing application data to determine that an application for credit card processing service is approved; and,
iv) automatically transmit to the merchant applicant data indicating that the application for credit card processing service is approved.

2. The system for automatically receiving and processing credit card processing applications according to claim 1, wherein the processor is programmed to use level of service data received from said merchant applicant to automatically determine pricing for said credit card processing service.

3. The system for automatically receiving and processing credit card processing applications according to claim 2, wherein the level of service data received from said merchant applicant comprises an expected number of transactions per month.

4. The system for automatically receiving and processing credit card processing applications according to claim 2, wherein the level of service data received from said merchant applicant comprises an expected dollar value of transactions per month.

5. The system for automatically receiving and processing credit card processing applications according to claim 2, wherein the level of service data received from said merchant applicant comprises an expected number of card-not-present transactions per month.

6. The system for automatically receiving and processing credit card processing applications according to claim 1, wherein the processor is further programmed to interface with merchant applicants using both a website portal and a mobile application.

7. The system for automatically receiving and processing credit card processing applications according to claim 2, wherein the processor is further programmed to consult a pricing matrix to determine one or more offer prices for one or more appropriate levels of service in view of the level of service data provided by the merchant applicant.

8. The system for automatically receiving and processing credit card processing applications according to claim 1, wherein the processor is further programmed to determine that further information is needed from the merchant applicant after submission of an application and contact the merchant applicant for said further information.

9. The system for automatically receiving and processing credit card processing applications according to claim 1, wherein said portal comprises a merchant applicant portal and a sales agent portal.

10. The system for automatically receiving and processing credit card processing applications according to claim 9, wherein the sales agent portal prompts a sales agent to enter merchant applicant data received from the merchant applicant.

11. The system for automatically receiving and processing credit card processing applications according to claim 1, wherein the processor is further programmed to transmit merchant applicant data to a third-party credit card processing company with a request for new service.

12. The system for automatically receiving and processing credit card processing applications according to claim 1, wherein the processor is further programmed to serve to the merchant applicant at least one form that includes electronic signature code for receiving an electronic signature by the merchant applicant.

13. The system for automatically receiving and processing credit card processing applications according to claim 1, wherein the processor is further programmed to serve to the merchant applicant at least one dashboard page that includes a display of status information for a pending application for credit card processing services.

14. The system for automatically receiving and processing credit card processing applications according to claim 13, wherein the dashboard page further comprises a display of pending actions that need to be taken by the merchant applicant prior to approval of said application for credit card processing services.
